(19) United States
(12) Patent Application Publication
(10) Pub. No.: US 2012/0173330 A1
(43) Pub. Date: Jul. 5, 2012

(54) Personalized Financial Planning Based on Transactional History

(75) Inventor: Michael Rodin, Ambler, PA (US)

(73) Assignee: The Western Union Company, Englewood, CO (US)

(21) Appl. No.: 12/980,687

(22) Filed: Dec. 29, 2010

(51) Int. Cl. G06Q 40/00; G06Q 30/00

(52) U.S. Cl. 705/14.49; 705/35; 705/36 R

(57) ABSTRACT

Methods and systems for analyzing a customer's financial position and providing the customer with a personalized financial plan are described. Information associated with one or more financial transactions using a financial network may be retrieved, wherein the one or more financial transactions were previously conducted by the customer. One or more periodic payments made using the financial network by the customer may be identified. Also, one or more periodic payments paid by the customer through the financial network may be identified. A personalized financial plan for the customer at least partially based on the one or more periodic payments paid and received by the customer through the financial network may be created.

### BACKGROUND OF THE INVENTION

Online bill payment and electronic money transfers are quickly becoming ubiquitous. While it may be possible for a person to send and receive money via an entity that provides such services, the information gathered during these transactions may be underutilized. For example, while a person may be able to pay his monthly bills electronically and receive funds and/or transmit funds to other persons or entities via the same or different electronic system, these payments made and received by the person may not be used to provide the person with useful financial data.

### BRIEF DESCRIPTION OF THE INVENTION

In some embodiments, a method for analyzing a customer's financial position and providing a customer with a personalized financial plan is present. The method may include receiving an enrollment request to enroll the customer in an interactive financial planning program, wherein the computer system is part of a financial network. The method may include retrieving from one or more databases, information associated with one or more financial transactions, wherein the one or more financial transactions were previously conducted by the customer. The method may include prompting the customer with one or more questions regarding the customer's financial position. The method may include receiving one or more responses from the customer corresponding to the one or more questions regarding the customer's financial position. The method may include identifying at least partially based on the information associated with one or more financial transactions retrieved from the one or more databases and the responses corresponding to the one or more questions, one or more periodic payments received by the customer through the financial network. The method may include identifying at least partially based on the information associated with one or more financial transactions retrieved from the one or more databases and the responses corresponding to the one or more questions, one or more periodic payments paid by the customer through the financial network. The method may include creating a personalized financial plan for the customer at least partially based on the one or more periodic payments paid and the one or more periodic payments received by the customer through the financial network. The method may include providing the personalized financial plan to the customer.

In some embodiments, the one or more periodic payments paid by the customer comprise one or more bill payment transactions. In some embodiments, the personalized financial plan identifies a surplus amount or a shortfall amount using the one or more periodic payments paid by the customer and the one or more periodic payments received by the customer. In some embodiments, the personalized financial plan comprises at least one suggested payment date for at least one or the one or more periodic payments paid by the customer. In some embodiments, the method includes prompting the customer with additional questions regarding the customer's financial situation. The additional questions may be divided into subsets of additional questions. Each subset of additional questions may be provided to the user during different sessions between the customer and the computer system of the financial network. In some embodiments, the method includes providing the customer with one or more investment opportunities that may be entered using the financial network, wherein the one or more investment opportunities are provided if the personalized financial plan identifies the surplus amount. In some embodiments, the method includes providing the customer with one or more credit opportunities that may be entered using the financial network, wherein the one more credit opportunities are provided if the personalized financial plan identifies the shortfall amount. In some embodiments, the method includes determining based on the periodic payments received by the customer and the periodic payments paid by the customer, the customer will be unable to complete an upcoming periodic payment; and sending an alert to the customer, wherein the alert notifies the customer that the customer has insufficient funds to complete the upcoming periodic payment.

In some embodiments, a computer program product stored on a computer-readable storage medium for analyzing a customer's financial position and providing a customer with a personalized financial plan is present. The computer program may include instructions for receiving an enrollment request to enroll the customer in an interactive financial planning program, wherein the computer system is part of a financial network. The computer program may include instructions for retrieving, from one or more databases, information associated with one or more financial transactions, wherein the one or more financial transactions were previously conducted and involved the customer. The computer program may include instructions for prompting the customer with one or more questions regarding the customer's financial position. The computer program may include instructions for receiving one or more responses from the customer that correspond to the one or more questions regarding the customer's financial position. The computer program may include instructions for identifying, at least partially based on the information associated with one or more financial transactions retrieved from the one or more databases and the one or more responses corresponding to the one or more questions, one or more periodic payments received by the customer using the financial network. The computer program may include instructions for identifying, at least partially based on the information associated with one or more financial transactions retrieved from the one or more databases and the one or more responses corresponding to the one or more questions, one or more periodic payments paid by the customer using the financial network. The computer program may include instructions for creating a personalized financial plan for the customer at least partially based on the one or more periodic payments paid and received by the customer through the financial network, and the one or more responses corresponding to the one or more questions regarding the customer's financial position. The computer program may include instructions for providing the personalized financial plan to the customer.

In some embodiments, a method for analyzing a customer's financial position and providing a customer with a personalized financial plan is present. The method may include receiving an enrollment request to enroll the customer in an interactive financial planning program, wherein the computer system is part of a financial network. The method may include retrieving from one or more databases, information associated with one or more financial transactions, wherein the one or more financial transactions involved the customer. The method may include identifying at least partially based on the information associated with one or more financial transactions retrieved from the one or more databases, one or more periodic payments received through the financial network by the customer. The method may include identifying at least partially based on the information associated with one or more financial transactions retrieved from the one or more databases, one or more periodic payments paid by the customer through the financial network. The method may include creating a personalized financial plan for the customer at least partially based on the one or more periodic payments paid and received by the customer through the financial network. The method may include providing the personalized financial plan to the customer. The method may include prompting the customer with additional questions regarding the customer's financial situation. The additional questions may be divided into subsets of additional questions. Each subset of additional questions may be provided to the user during different sessions between the user and the computer system of the financial network. The method may include receiving responses to the additional questions from the customer. The method may include modifying the personalized financial plan based on the responses to the additional questions received from the customer.

### BRIEF DESCRIPTION OF THE DRAWINGS

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

The present invention is described in conjunction with the appended figures:

FIG. 1 illustrates a simplified embodiment of a financial network.

FIG. 2 illustrates another simplified embodiment of a financial network.

FIG. 3 illustrates a simplified embodiment of a personalized financial plan generated by a financial server system.

FIG. 4 illustrates a simplified method of creating a personalized financial plan.

FIGS. 5a and 5b illustrate a simplified method of creating and modifying a personalized financial plan.

FIG. 6 is a block diagram of an exemplary computer system capable of being used in at least some portion of a financial network.

### DETAILED DESCRIPTION OF THE INVENTION

Personalized financial planning may be provided to a customer by analyzing his past financial transactions. This may involve analyzing the customer's previous bill payments and money transfer transactions, including money transfers received and sent by the customer, collectively referred to as the customer's transaction history. Based upon this information, a determination of the amount of money a customer typically sends and receives via a financial network over a period of time may be determined. This information may be supplemented with information gathered directly from the customer. This information may be gathered through direct questions posed to the customer. These questions may be based at least partially on the customer's transaction history. Additionally, to gather further information on the customer's financial position, third parties may be contacted. For example, one or more banks and/or credit bureaus may provide the financial server system with additional information about the customer's financial position.

Based upon the information gathered from the customer's transaction history, the customer, and third parties, the customer may be presented with a personalized financial plan. This personalized financial plan may recommend various ways in which the customer could increase his financial wellbeing. For example, the financial server system may propose one or more dates on which it would be beneficial for the customer to complete a bill payment or money transfer. The financial server system may also be able to extrapolate to a future date where it determines that the customer's income will no longer be sufficient to cover the customer's obligations. The financial server system may provide the customer with an alert that indicates when the financial server system has predicted the customer will run out of funds.

Such personalized financial planning may provide advertising opportunities to the money transfer service provider that operates the financial server system. Due to the access the money transfer service provider has to the customer's transaction history and, possibly, to information provided by the customer and/or from third parties, the money transfer service provider may be able to accurately direct advertising to the customer's current financial position. When the customer is facing a shortfall in funds, the money transfer service provider may provide advertising directed to credit and/or loans. When the customer has a surplus of funds, the financial server system may provide advertisements for various investment opportunities.

In an effort to provide a more accurate personalized financial plan and/or advertising, the customer may be encouraged to periodically answer questions directed to the customer's finances. In some embodiments, the customer may be prompted to answer one or more questions directed to his financial position each time the customer interacts with the financial network. Over time, these questions may provide an accurate picture of the customer's financial position. In some embodiments, the customer is rewarded for answering more questions. For example, a customer may be provided with an opportunity to fill out a financial survey in order to receive a reward or incentive, such as loyalty points or discounts on money transfer services.

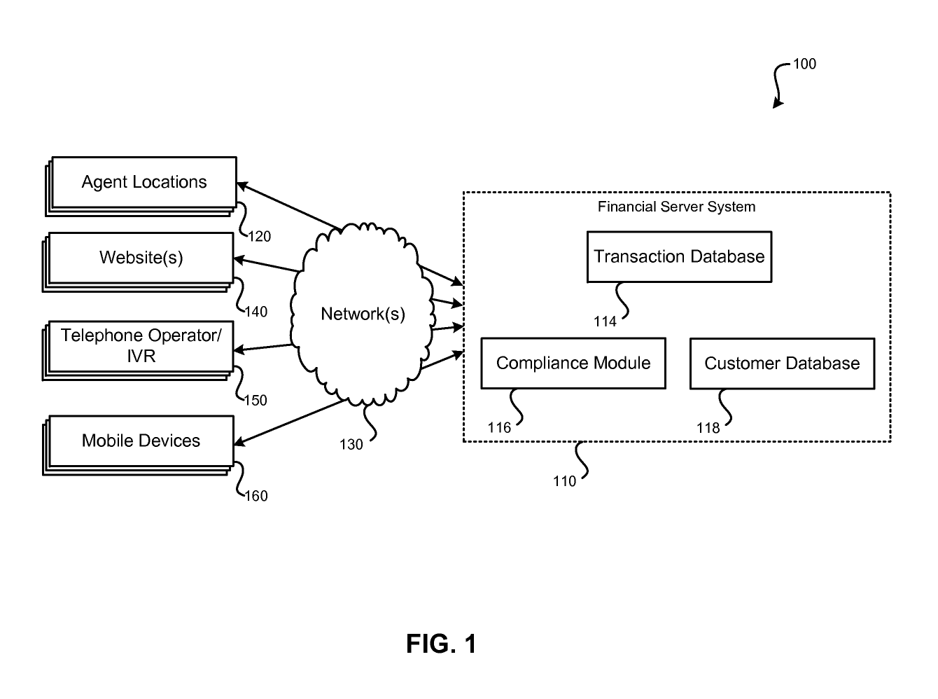

To implement such personalized financial planning, a financial network may be used. FIG. 1 illustrates a simplified embodiment of a financial network 100. Such a financial network, possibly a money transfer network, may be operated by an entity such as WESTERN UNION and may be capable of performing a variety of money transfer transactions from payors to payees. For example, financial network 100 may be capable of performing money transfers, wire transfers and bill payment transactions. Other services may include the ability to issue and reload prepaid stored value cards with funds, and the ability to send gift cards to a party (and reload such cards with funds). A money transfer may be made from one party to another party, and may involve cash being transferred. Financial network 100 may include one or more agent locations 120, one or more websites 140, telephone operator and/or interactive voice response (IVR) systems 150, mobile devices 160, a financial server system 110, a transaction database 114, a compliance module 116, and/or a customer database 118.

Agent locations 120 may represent various kiosks and/or other physical locations where payors (persons sending funds) and payees (persons receiving funds) may conduct money transfer transactions. For example, WESTERN UNION may have hundreds of thousands of agent locations scattered worldwide. At agent locations 120, a person, such as a clerk, may serve as a representative of the entity providing the money transfer service. Payors and payees may conduct money transfer transactions by interacting directly with an agent of the money transfer entity at an agent location. Transactions conducted at an agent location may be conducted using a variety of different payment methods. For example, cash, checks, credit cards, debit cards, and stored value cards are all possible methods through which a payment may be received from a payor or provided to a payee. Also, at an agent location, payors and payees may interact directly with a kiosk that is part of the financial network 100. Alternatively, the agent of the money transfer service provider may interact with the kiosk on behalf of the payor or payee.

Financial network 100 may include one or more websites. Such websites may allow payors and payees to conduct money transfer transactions via the Internet. A payor may provide payment and transaction information to financial network 100 via website 140. For example, a payor may provide bank account information or credit card information to financial network 100 via website 140. Likewise, payees may receive payments sent via financial network 100 using website 140. For example, it may be possible for a payee to provide a bank account number for funds to be deposited via website 140. Website 140 may also permit a payor or payee to determine the status of a money transfer transaction. If a payor is conducting the money transfer using a bank account, credit card, stored value card, or using some other payment method besides cash, he may be able to conduct the entire payor-side transaction using website 140. Likewise, if the payee is receiving the funds via a method other than cash, he may be able to complete his payee-side transaction using website 140. Alternatively, if either the payor and payee is conducting the transaction in cash, some of the information necessary to conduct the money transfer transaction may be supplied via website 140, with the cash being transacted at an agent location of agent locations 120.

Financial network 100 may also include a telephone operator and/or interactive voice response (IVR) system 150. Telephone operator and/or IVR system 150 may allow a payor and/or payee to conduct the money transfer transaction via a telephone call to the telephone operator and/or IVR system 150. Payors and payees may provide the information necessary to conduct the money transfer transaction via the telephone, either to a human operator, or to an interactive voice response system. If a payor is conducting the money transfer using a bank account, credit card, stored value card, or using some other payment method besides cash, he may be able to completely conduct the transaction using the telephone operator and/or IVR system 150. Likewise, if the payee is receiving the funds via a method other than cash, he may be able to complete the transaction using the telephone operator and/or IVR system 150. Alternatively, if either the payor and payee is conducting the transaction in cash, some of the information necessary to conduct the money transfer transaction may be supplied via the telephone operator and/or IVR system 150, with the cash being transacted at an agent location of agent locations 120.

Also, it may be possible to interact with financial network 100 via mobile devices 160. Mobile devices 160 may represent various wireless devices that can communicate with financial network 100. For example, Mobile devices 160 may include cellular telephones, smart phones, laptops, tablet computers, etc. Mobile devices 160 may load a website to interact with financial network 100. Alternatively, mobile devices 160 may run one or more pieces of software, such as applications or firmware configured to allow interaction with financial network 100. Via a mobile device of mobile devices 160, it may be possible for a payor to transmit funds to a payee. Also, it may be possible for a payee to receive funds via a mobile device of mobile devices 160. If a payor is conducting the money transfer using a bank account, credit card, stored value card, or using some other payment method besides cash, he may be able to complete the transaction using a mobile device of mobile devices 160. Likewise, if the payee is receiving the funds via a method other than cash, he may be able to complete the transaction using a mobile device of mobile devices 160. Alternatively, if either the payor and payee is conducting the transaction in cash, some of the information necessary to conduct the money transfer transaction may be supplied via a mobile device of mobile devices 160, with the cash being transacted at an agent location of agent locations 120.

Agent locations 120, website 140, telephone operator and/or IVR system 150, and mobile devices 160 may communicate with financial server system 110 via a network 130. Network 130 has been represented as a single network in FIG. 1. This is for simplicity only: network 130 may include several networks. Further, the network used for agent locations 120 to communicate with financial server system 110 may be different from the network used by mobile devices 160 to communicate with financial server system 110. The network 130 may include one or more public networks, such as the Internet, and one or more private networks, such as a corporate intranet. Further, multiple networks may be used to communicate with financial server system 110. For example, mobile devices 160 may use a wireless cellular provider's network and the Internet to communicate with financial server system 110.

Whether a payor provides funds to the financial network 100 via agent locations 120, website 140, telephone operator and/or IVR system 150, or mobile devices 160, this may not affect how a payee may receive the funds. For example, while a payor may provide funds via website 140, a payee may retrieve the funds via one of agent locations 120. It may also be possible for a payor to use the same entity, such as agent locations 120, to conduct a money transfer transaction.

Financial server system 110 may include one or more various subsystems used to conduct a money transfer transaction. For example, a customer database 118 may be present. Customer database 118 may store biographical information about the money transfer service provider's customers (payors and payees).

Transaction database 114 may store information on pending and completed money transfer transactions. Transaction database 114 may identify amounts of funds provided by payors, amounts of funds due to payees, payors' names and addresses, the payees' names and addresses, transaction identifiers such as money transfer control numbers (MTCNs), the locations where the transactions were initiated (e.g., the website, an address of the agent location), the location of where the transaction is expected to be completed (e.g., where the payee is expected to receive the funds), the payor's payment method (e.g., cash, credit card, money order, stored value card, check, etc.), and whether or not various money transfer transactions have been completed or are pending.

Compliance module 116 may be used to ensure compliance with government regulations. For example, the money transfer service provider operating the financial network 100 may be required to comply with various government regulations (possibly varying by country) intended to prevent fraudulent and/or illegal use of financial networks. An example of a compliance measure that the money transfer service provider may use is a list of persons that the money transfer service provider is prohibited from doing business with published by the Office of Foreign Asset Control (OFAC). The money transfer service provider may be required by law to not do business with (e.g., as a payor or payee) persons published on such a list. Other compliance measures may include gathering additional information about payors and payees conducting a money transfer that exceeds a particular amount and/or is international. Money transfer transactions being conducted with cash may also include additional compliance measures. Therefore, depending on the location of the payor and payee, the amount of the money transfer, and the payment method, each money transfer may be subject to varying levels of examination and regulation by compliance module 116.

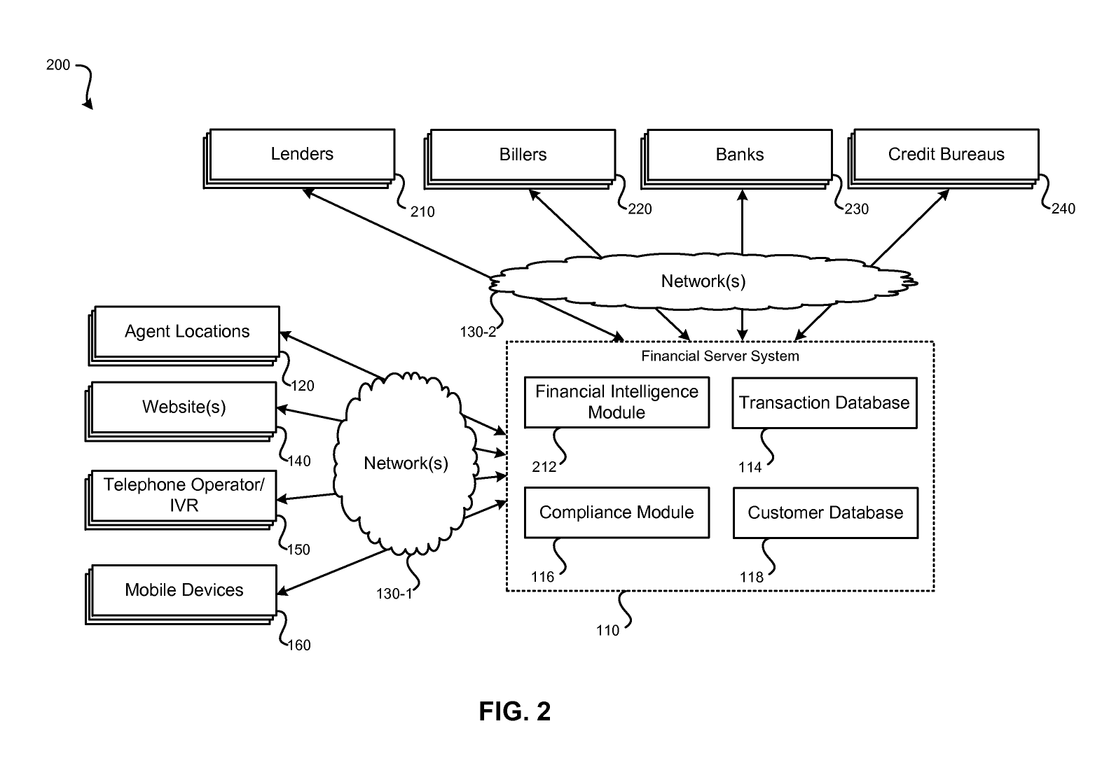

Financial network 100 may be used by payors, payees, and third parties to conduct money transfer transactions. This financial network may provide a payor and/or payee with personalized financial planning at least partially based on the customer's (who is either the payor or payee) financial history. FIG. 2 illustrates another embodiment of a financial network 200. Financial network 200 may represent the same financial network as financial network 100 of FIG. 1. Alternatively, financial network 200 may represent some other financial network.

As in financial network 100 of FIG. 1, financial network 200 of FIG. 2 may comprise one or more agent locations 120, one or more websites 140, a telephone operator/IVR system 150, and mobile devices 160. Further, financial server system 110 may comprise a transaction database 114, a compliance module 116, and/or a customer database 118. Additionally, the financial server system 110 of financial network 200 may include a financial intelligence module 212. Financial intelligence module 212 may analyze records of transactions (possibly including transactions stored in transaction database 114), data gathered directly from customers, data stored in the customer database 118, and/or a data received from third-party entities.

These third-party entities may represent entities that have records containing information regarding a customer's financial status. FIG. 2 illustrates four possible third-party entities; however, it should be understood that other third-party entities may also be possible. FIG. 2 illustrates lenders 210, billers 220, banks 230, and credit bureaus 240. Lenders 210 may send information to financial server system 110 detailing various loans that a customer holds with lenders 210. This information may be released by lenders 210 to financial server system 110 only after receiving permission from the customer. Similarly, billers 220 may provide information regarding bills typically paid by the customer. Banks 230 may provide information regarding various accounts, loans, credit cards, and/or investments held by the customer at banks 230. Credit bureaus 240 may provide information regarding the customer's credit rating. Each of these third-party entities may communicate with financial server system 110 via network(s) 130-2. Network(s) 130-2 may represent the same or different network(s) from network(s) 130-1. Network(s) 130 may include the Internet, a private local area network, a wireless service provider's network, and/or any other network through which entities may electronically communicate.

Financial intelligence module 212 may use some or all of the information provided by the various third-party entities, transaction database 114, customer database 118, and/or questions asked directly to the customer to create a personalized financial plan for the customer. Financial intelligence module 212 may be configured to provide suggested dates on which the customer may pay for bills or other financial obligations. Financial intelligence module 212 may also determine whether a customer is more likely to be interested in receiving credit or investment opportunities. This information may be used to provide directed advertising to the customer. Financial intelligence module 212 may be able to interact with the customer via agent locations 120, websites 140, telephone operator/IVR system 150, and/or mobile devices 160. No matter which of these interfaces the customer uses to interact with financial server system 110, financial intelligence module 212 may be able to provide the customer with a personalized financial plan via the interface and interrogate the customer for additional financial information.

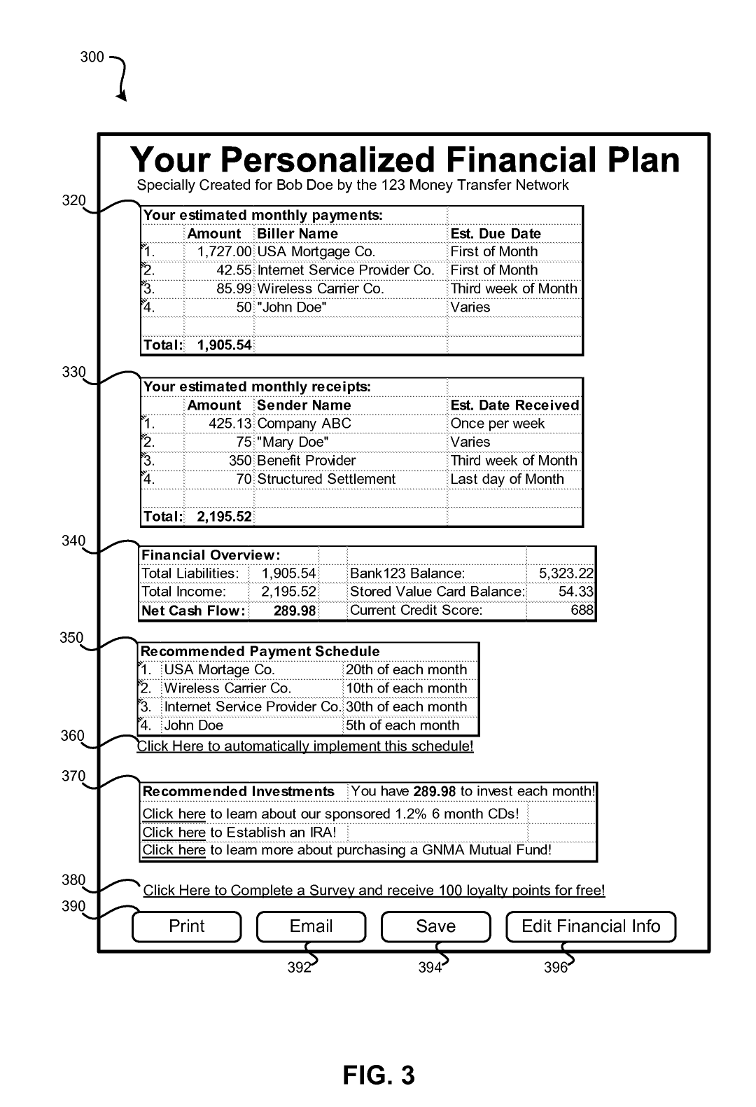

FIG. 3 illustrates an embodiment of a personalized financial plan 300. The personalized financial plan of FIG. 3 may be created by the financial intelligence module 212 of FIG. 2. Alternatively, some other financial intelligence module may create such a personalized financial plan for the customer.

In table 320, the personalized financial plan may estimate or otherwise determine various monthly payments that a customer makes. These estimated payments may be based on the customer's financial transaction history. For example, a transaction database, such as transaction database 114 of FIG. 1, may reveal that the customer makes a payment to a particular biller on or roughly on the same day of each month. Referring to table 320, an estimated payment is listed for “USA Mortgage Company.” The amount here is $1727. Further, it is determined that the payment is due to USA Mortgage Company on roughly the first of each month. This estimated monthly payment may be determined based on the customer having previously, such as for multiple months in a row, made a payment of roughly $1727 to USA Mortgage Company around the first of each month. Table 320 also lists payments be made to “Internet Service Provider Company”, “Wireless Carrier Company” and a person named John Doe. As with the amount due to USA Mortgage Company, the amounts due to these three entities may be based on previous transactions, the amount of these past transactions, and the time of month when these transactions are usually conducted. A customer may also be prompted to specify bills that are due periodically. For example, referring to table 320, the customer may specify that he periodically makes payments to a person named John Doe. In some embodiments, a biller may notify the financial server system that the customer makes a periodic payment. For example, Wireless Carrier Company may have notified the financial server system that the customer pays roughly $85.99 during the third week of each month. Based on the total of the payments made by the customer, a total monthly payment amount may be provided to the customer on the personalized financial plan. It should be noted, that while table 320 identifies various monthly payments, other time periods are possible. For example, table 320 may identify weekly or yearly amounts due. Further, while table 320 may initially contain estimated amounts and due dates, these amounts and due dates may be replaced by the actual, exact amount and due date based on information submitted by the biller as it becomes available.

While table 320 identifies various payments made by the customer, table 330 identifies various payments received by the customer. Transactions appearing in table 330 may be based upon the customer's financial transaction history. For example, a transaction database, such as transaction database 114 of FIG. 1, may provide historical information used to estimate various amounts received by the customer from various senders. As with the information in table 320, the transaction information of table 330 may also be gathered from questions posed directly to the customer and/or information received from third-party entities. Table 330 may provide a total of the amount of money expected to be received by the customer per month. As with table 320, while table 330 estimates monthly receipts, it may also be possible to estimate amounts received for other time periods, such as per week or per year.

A third table, table 340, may provide the customer with a financial overview. This financial overview may include the estimated total liabilities of the customer, the estimated total income of the customer, and information regarding various accounts of the customer, such as bank account balances, stored value card balances, and credit card balances. The customer may also be provided with his credit score.

In table 350, the customer may be provided with a recommended payment schedule. The recommended payment schedule may be created based on the customer's obligations (expressed in table 320) and when the customer is expected to receive funds (expressed in table 330). The recommended payment schedule may identify recommended payment dates based on when the customer is likely to have enough funds to cover the amounts due to cover his obligations to the billers. The recommended payment schedule may also take into effect the actual or estimated due date of the bills. The customer may be provided with an option to automatically implement the recommended payment schedule of table 350. Link 360 provides an opportunity for the customer to automatically implement a payment schedule. Automatically implementing a payment schedule may include reminders being sent to the customer and/or the actual payment being transmitted to the biller on the recommended payment date.

Table 370 may vary depending on the obligations and income of the customer. For example, if the total income of the customer exceeds the customer's total obligations, table 370 may recommend various investments for the customer. Alternatively, if the obligations of the customer exceed the customer's total income, table 370 may recommend various sources of credit for the customer. In FIG. 3, the total income of the customer exceeds his total liabilities. Therefore, table 370 indicates recommended investments. The recommended investments may vary depending on the net cash flow the customer has, that is, the amount of money the customer has per month (or week or year) available to invest. In FIG. 3, the recommended investments of table 370 include a promotional rate on certificates of deposit, a promotion to establish a retirement account, and a recommended mutual fund. In place of recommended investments, recommended sources of credit may be provided, the customer may have the ability to apply for credit through the money transfer service provider. Alternatively, various third parties may provide advertisements offering the customer credit, possibly in the form of a loan or a credit card.

Link 380 may provide a promotion to the customer to entice him to provide more personal financial information. This additional financial information may be used to provide a more accurate personalized financial plan to the customer and/or provide the customer with more relevant advertising. In order to entice the customer to provide additional financial information, the customer may be offered an incentive in return. For example, in the embodiment of FIG. 3, the customer receives 100 loyalty points for “free.” Also, each time the customer accesses his personalized financial plan, he may be prompted with additional questions which she may or may not be required to answer to access his personalized financial plan. Over time, the repeated use of providing the customer with additional questions may serve to create a more complete picture of the customer's finances.

Depending on the interface the customer is accessing the personalized financial plan through, the customer may be presented with various options to interact with the personalized financial plan. For example if the customer is accessing his personalized financial plan via the Internet, he may have been presented with various buttons through which to interact with his personalized financial plan, such as print button 390, e-mail button 392, save button 394, and edit financial information button 396.

It should be understood that personalized financial plan 300 of FIG. 3 is only an exemplary embodiment. Various other personalized financial plans may represent other information not presented in FIG. 3. For example, in some embodiments, additional advertising may be present.

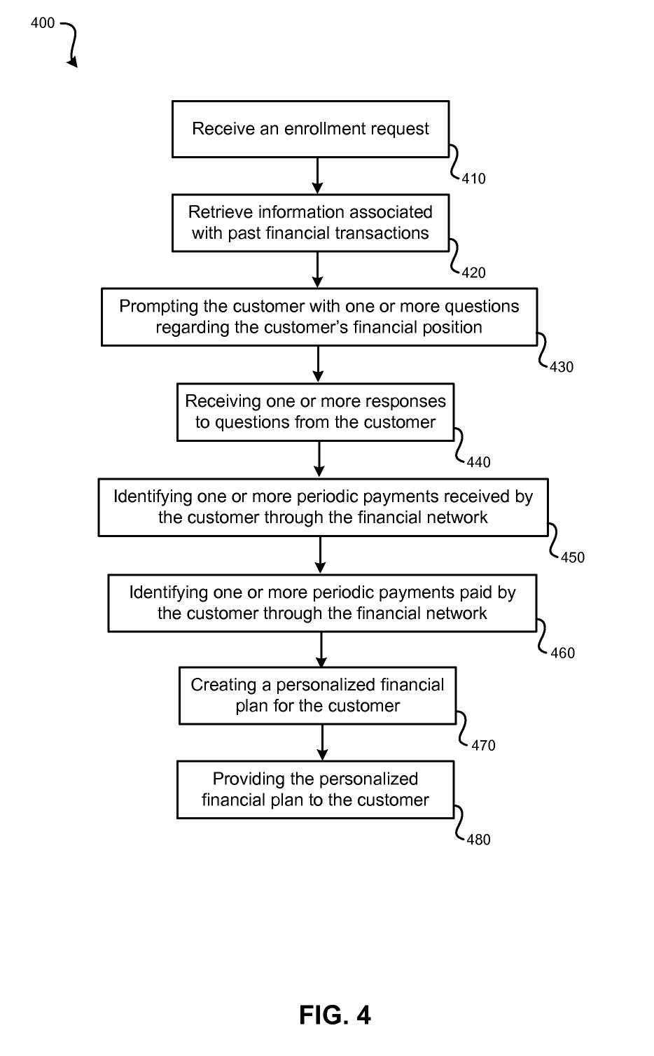

The personalized financial plan of FIG. 3 may be created using a financial server system, such as part of financial network 200 of FIG. 2. A method, such as method 400 of FIG. 4 may be used by financial network 200 of FIG. 2 to produce the personalized financial plan of FIG. 3, or to produce some other personalized financial plan, using an interactive financial planning arrangement.

At block 410, and enrollment request may be received from the customer. Such an enrollment request may be received through any of the financial network's interfaces, such as a website, an agent location, and IVR system, or a mobile device. The enrollment request may require the customer to agree that his or her previous transactions conducted using the financial network and/or other financial information stored with various third parties be used to create the personalized financial plan.

At block 420, information associated with the customer's past financial transactions involving the financial network may be retrieved. This may involve past financial transactions over some period of time, such as the past year, being retrieved if the customer was either the payor or the payee.

At block 430, the customer may be prompted with one or more questions regarding the customer's financial position. For example, these questions may involve the customer's financial liabilities, such as if he has a mortgage, credit card bills, utilities, alimony payments, child support payments, car payments, etc. These questions may focus on information that cannot be determined from the customer's transaction history, such as the income he earns from his job, the size of his family, the amount, if any, of his rent or mortgage payment, his future goals (e.g., saving for college, saving for a new car, saving for retirement, paying off debt). The answers to these questions may be used to supplement the information determined from the customer's transaction history.

At block 440, one or more responses to the questions prompted may be received from the customer. Additional questions may be determined based on the customer's responses. For example, if the customer responds that he is attempting to pay off debt, a later question may enquire how much debt he has and what the interest rate on the debt is.

At block 450, one or more periodic payments received by the customer through the financial network may be identified. These payments may be sent by an entity, such as a business, non-profit organization, or a government, or a person, such as a relative, friend, ex-spouse, etc. The financial server system may access a transaction database, such as transaction database 114 of FIGS. 1 and 2, for a predetermined time period, such as the previous year, to review transactions in which the customer is the recipient. If the same payor (or sender) send the customer funds more than some threshold amount of times at regular or near regular intervals, the transaction may be identified as a periodic payment. If the amount varies per payment, the average amount of the transaction may be estimated to be the amount expected to be received by the customer. As an example, if a person named “John Doe” sent the customer $150 on June 2nd, $140 on July 5th, and $180 on August 4th, the financial server system may identify this as a periodic payment. The payment may be identified as a payment from John Doe that occurs during the first week of each money for approximately $157. At block 460, zero, one or more than one period payments may be identified by the financial server system.

At block 460, one or more periodic payments paid by the customer through the financial network may be identified. These payments may be sent by the customer to an entity such as a business (e.g., a billpay transaction), non-profit organization, or the government, or to an individual person. Again here, the financial server system may access the transaction database, such as transaction database 114 of FIGS. 1 and 2, for a predetermined time period, such as the previous year, to review transactions in which the customer is the payor (sender). If the same payee (or recipient) has received funds from the customer more than some threshold number of times at regular or near regular intervals, the transaction may be identified as a periodic payment. If the amount varies per payment, the average amount of the transaction may be estimated to be the amount expected to be paid by the customer. As an example, if the customer sends an entity called “Mortgage123 Co.” a payment of $3427.81 on or around the 5th of each month, the financial server system may identify this as a periodic payment. Depending on the transactions the customer has previously been involved with, zero, one, or more than one periodic payments made by the customer may be identified by the financial server system.

At block 470, the periodic payments identified at blocks 450 and 460 and the responses received to questions at block 440 may be used to create a personalized plan for the customer. This personalized financial plan may appear or contain similar information to personalized financial plan 300 of FIG. 3. At block 480, the personalized financial plan may be presented to the customer. The personalized financial plan may be initially presented to the customer via whichever interface the customer is using to interact with the financial network. For example, if the customer is utilizing a website of the financial network, the personalized financial plan may be presented to the customer as a webpage or email. If the customer is utilizing an agent location, the customer may be provided with a printout of the personalized financial plan or a display of the plan on a kiosk. If the customer is interacting with the financial network via an operator or IVR system telephonically, the financial plan may be mailed or emailed to him. Finally, if the customer is interacting with the financial network from a mobile device, such as a cell phone, the personalized financial plan may be displayed on the mobile device or emailed to the customer. Of course, other possibilities exist for how the personalized financial plan will be presented to the customer.

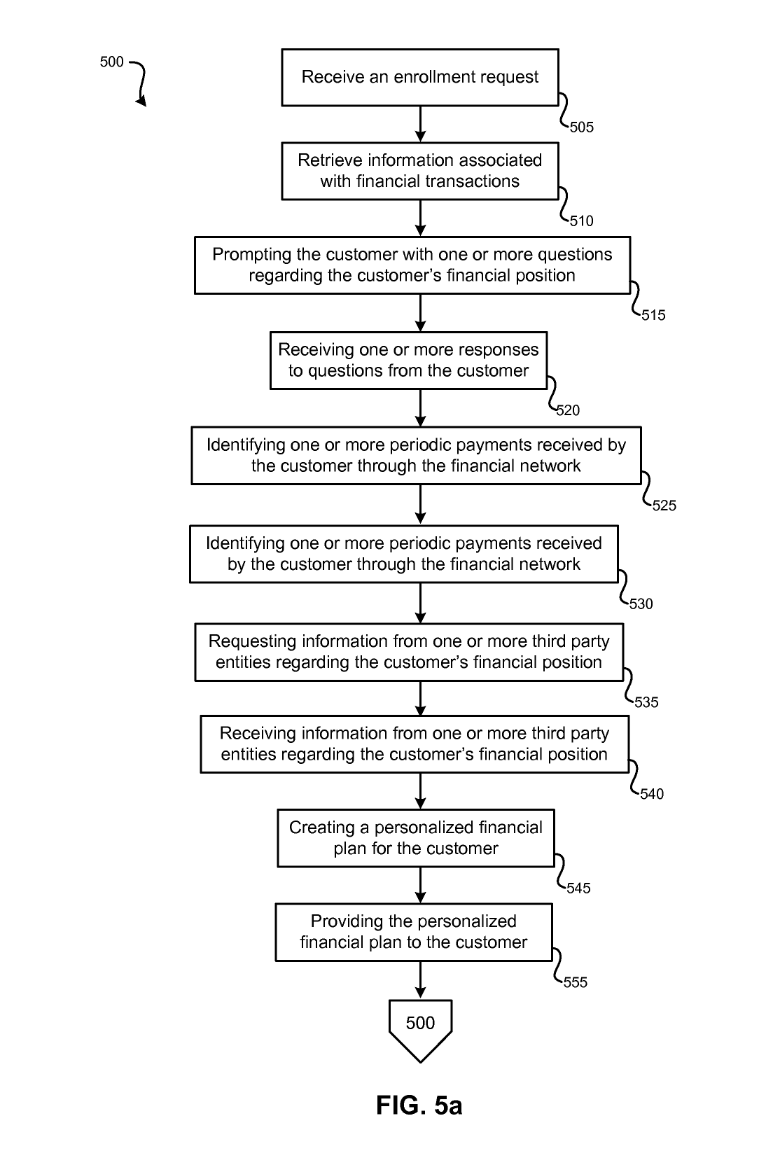

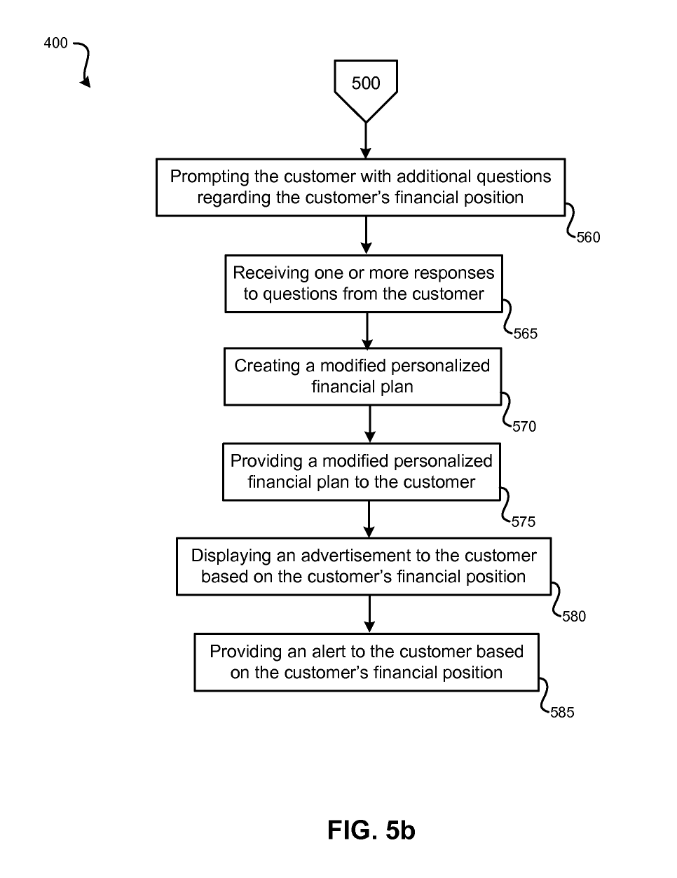

FIGS. 5a and 5b illustrate another method 500 that may be used by financial network 200 of FIG. 2 or financial network 100 of FIG. 1 to produce the personalized financial plan of FIG. 3 or some other personalized financial plan. Method 500 may represent the same method as method 400 of FIG. 4 or may represent some other method for using an interactive financial planning arrangement to produce a personalized financial plan. At block 505, an enrollment request from the customer may be received from the customer. This enrollment request may be in response to a prompt provided to the customer that inquires whether the customer is interested in receiving a personalized financial plan. The enrollment request may contain an agreement that the customer is required to agree to that indicates that the customer allows his past financial transactions (and possibly transactions involving third party entities) to be accessed to create the personalized financial plan. The enrollment request may also require the customer to provide basic information to the financial server system, such as biographical information of the customer (e.g., his social security number, full name, current and past addresses, customer loyalty number, etc.).

At block 510, information may be retrieved from one or more databases regarding past financial transactions the customer was involved in. This may involve past financial transactions over some period of time, such as the past year, being retrieved if the customer was either the payor or the payee. Such financial transactions may be retrieved from a transaction database, such as financial transaction database 114 of FIG. 1 and FIG. 2, or some other financial transaction database.

At block 515, the customer may be prompted with one or more questions regarding the customer's financial position. This block may be similar to block 430 of FIG. 4. For example, these questions may involve the customer's financial liabilities, such as if he has a mortgage, credit card bills, utilities, alimony payments, child support, car payments, etc. These questions may focus on information that cannot be determined from the customer's transaction history, such as the income he earns from his job, the size of his family, the amount, if any, of his rent or mortgage payment, his future goals (e.g., saving for college, saving for a new car, saving for retirement, paying off debt). The answers to these questions may be used to supplement the information derived from the customer's transaction history.

At block 520, one or more responses to the questions may be received from the customer. Additional questions may be determined based on the customer's responses. For example, if the customer responds that he is attempting to pay off debt, a later question may enquire how much debt he has and what the interest rate on the debt is.

At block 525, one or more periodic payments received by the customer through the financial network may be identified. This block may be similar to block 450 of FIG. 4. These payments may be sent by an entity, such as a business, non-profit organization, or a government, or a person, such as a relative, friend, ex-spouse, etc. The financial server system may access a transaction database, such as transaction database 114 of FIGS. 1 and 2, for a predetermined time period, such as the previous year, to review transactions in which the customer is the recipient. This transaction information may have already been retrieved at block 510. If the same payor (or sender) sends the customer funds more than some threshold amount of times at regular or near regular intervals, the transaction may be identified as a periodic payment. If the amount varies per payment, the average amount of the transaction may be estimated to be the amount expected to be received by the customer. At block 525, zero, one or more than one period payments may be identified by the financial server system. Additionally, the customer may be requested to answer questions related to the payments determined to be periodic. For example, the customer may be asked whether a periodic payment as identified by the financial server system is indeed periodic. The customer may also be asked whether the amount or payment date varies and what the expected payment amount is. The customer may also be asked for additional information on who is sending the money, such as their full name, address, relationship with the customer, etc. The responses to these questions may be used to provide a more accurate personalized financial plan.

At block 530, one or more periodic payments paid by the customer through the financial network may be identified. Block 530 may be similar to block 460 of FIG. 4. These payments may be sent by the customer to an entity such as a business (e.g., a billpay transaction), non-profit organization, or the government, or to an individual person. Again here, the financial server system may access the transaction database, such as transaction database 114 of FIGS. 1 and 2, for a predetermined time period, such as the previous year, to review transactions in which the customer is the payor (sender). The transaction records may have already been retrieved from the transaction database at block 510. If the same payee (or recipient) has received funds from the customer more than some threshold number of times at regular or near regular intervals, the transaction may be identified as a periodic payment. If the amount varies per payment, the average amount of the transaction may be estimated to be the amount expected to be paid by the customer. Depending on the transactions the customer has previously been involved with, zero, one, or more than one periodic payments made by the customer may be identified by the financial server system. Additionally, as at block 525, the customer may be requested to answer questions related to the payments determined to be periodic. For example, the customer may be asked whether the identified periodic payments are indeed periodic. The customer may also be asked whether the amounts or payment dates vary and what the expected payment amount is. The customer may also be asked for additional information on who is receiving the money, such as their full name, address, relationship with the customer, etc. The responses to these questions may be used to provide a more accurate personalized financial plan.

To supplement the information gathered from past transactions, information may be requested from one or more third party entities. Assuming that a customer gives permission (such as via the terms presented to the customer at the time of enrollment), the financial server system may request information from one or more banks (possibly banks that the customer has stated he has a relationship with) regarding accounts, credit cards, loans, etc. The financial server system may request the customer's credit rating from one or more credit bureaus. The financial server system may contact one or more mortgage lenders (again, possibly mortgage lenders that the customer has stated that he has a relationship with). The financial server system may also request information from one or more billers. These may be billers to which the customer has previously paid bills through the financial network. Information may also be requested from other third parties.

At block 540, some or all of the information requested from the third parties may be received by the financial server system. This information may be used to supplement or replace information retrieved from the transaction database and directly from the customer.

At block 545, a personalized financial plan may be created for the customer using the information gathered in blocks 505 through 540. The personalized financial plan may be similar to the personalized financial plan 300 of FIG. 3. Of course, alternative embodiments of a personalized financial plan are possible in both layout and information presented. Based upon the total number of periodic payments received by the customer and the total number of periodic payments made by the customer, in conjunction with the information gathered from third-party entities and the customer, an estimated net cash flow of the customer may be determined. This information may be provided to the customer as part of his personalized financial plan.

As part of the personalized financial plan, the financial server system may create a recommended payment schedule. This recommended payment schedule may be based on the amounts and dates of the periodic payments, information provided by third parties, and information provided directly by customers. The payment schedule may schedule payments based on when the financial server system determines the customer is likely to have funds available to complete the payment and when the due dates of the payments are. For example, if on the first of each month a customer is expected to receive $1000 in funds, the financial server system may recommend that on the second the customer pay his mortgage bill of $800 and his electric bill of $75.

The personalized financial plan may also vary depending on whether the customer has a positive or a negative net cash flow. If the total number of payments made by the customer exceeds the total number of payments received by the customer, the customer may be determined to have a negative cash flow. In some embodiments, information provided by the customer and third parties is also taken into account when determining the net cash flow. When the net cash flow is determined to be negative, advertisements and/or other information may be presented to the user which may be of use to someone with a negative cash flow. For example, advertisements and/or opportunities to obtain loans and/or credit cards may be presented to the customer. Other examples include advertisements for financial counseling services and recommendations for better managing one's finances. Conversely, if the customer has a positive net cash flow, instead of offering opportunities in advertisements targeted to loans and credit, advertisements and are opportunities directed to investments and/or other possible expenditures may be presented to the customer. For example, the customer may be offered various bank accounts, retirement accounts, mutual funds, or other investments that the customer could directly purchase or enroll in through the personalized financial plan. Based on the amount of the customer's net cash flow, advertisements could also be targeted based on the magnitude of the net cash flow. For example, if the customer has a large positive net cash flow, advertisements may be targeted towards large purchases, such as big-screen TVs and/or vehicles, to name only a couple examples. If the customer has only a small positive cash flow, the customer may be presented with advertisements targeting smaller purchases, such as clothing or consumer electronics, again to name only a couple examples.

If the financial server system determines that the personalized financial plan may benefit from more information being provided by the customer, the personalized financial plan may include one or more incentives to entice the customer to provide more information regarding his personal financial background. For example, a link to a survey may be provided to the customer. In exchange for completing the survey, the customer may receive some sort of incentive, such as some number of loyalty points or a discount on future services rendered by the financial server system. The information gained by a customer entering additional questions such as in the form of a survey may allow the financial server system to provide an more detailed and accurate personalized financial plan and/or target advertising and/or other opportunities to the customer more effectively.

At block 555, similar to block 480 of FIG. 4, the personalized financial plan may be presented to the customer. The personalized financial plan may be initially presented to the customer via whichever interface the customer is using to interact with the financial network. Once the personalized financial plan has been created, the customer may be able to access the personalized financial plan via any of the interfaces made available to the financial network. For example, while the customer may have initially received the personalized financial plan at an agent location, the customer may be able to access the personalized financial plan in the future using a website of the financial network.

Method 500 of FIG. 5a continues on FIG. 5b. At block 560, the customer may be prompted with additional questions regarding the customer's financial position. This step may not occur during the customer's same session with the financial network in which the customer was initially presented with his personalized financial plan. Rather, the customer may be presented with additional questions some or each of the times the customer interacts with either the financial server system or his personalized financial plan during future sessions. Out of a set of additional questions, the customer may be presented with a subset of these additional questions each time he accesses the financial network. As such, these additional questions may allow additional information to be gathered regarding the customer's financial position and/or changes to the customer's financial position. Further, by spreading out subsets of additional questions over multiple sessions annoying the customer with too many questions at one time may be avoided. To be clear, a session may refer to an interaction between the customer and the financial network. For example, if a user enters an agent location, interacts with the financial network, that leaves, this may be referred to as one session. Similarly, if the customer logs on to the financial networks website and interacts with the system in such a manner, this may be referred to as another session.

At block 565, responses may be received to the questions prompted at block 560.

At block 570, the customer's personalized financial plan may be modified according to the additional questions answered by the customer. This may involve advertisements, credit opportunities, investment options, and/or other financial data being more accurately presented and/or targeted to the customer. At block 575, this modified personalized financial plan may be provided to the customer via any of the interfaces previously described for which the customer may interact with the financial network.

The information gathered by the financial server system to create the customer's personalized financial plan may also be used to target advertisements presented to the customer outside of his personalized financial plan. For example, if the customer is attempting to conduct a money transfer transaction (and is not interacting with his personalized financial plan) or more advertisements may be presented to the customer based on some or all of the information gathered to create the personalized financial plan. For example, the advertisement may rely on the customer's biographical information (possibly gathered during enrollment in the personalized financial plan from the customer), the customer's periodic payments both received and sent, information received from third parties, and information received directly from the customer.

At block 585, an alert may be provided to the customer based on the customer's financial position. Periodically, the financial server system may analyze the customer's financial position. This may involve analyzing some or all of the information used to create the customer's personalized financial plan. Based on the customer's periodic payments made and received, the financial server system may determine that on or around a certain date the customer will face a shortfall in funds necessary to meet the customer's obligations. As an example of this, consider a situation where a customer has a mortgage payment on or around the 15th of the month for $2000. The customer's personalized financial plan may indicate that the customer's bank account has $600 in it. The personalized financial plan may also indicate the customer is expected to receive a periodic payment of $1000 by the 10th of the month. This leaves a shortfall of $400. Once the shortfall has been determined by the financial server system, the customer may be alerted of this shortfall in order for the customer to attempt to remedy the shortfall before the mortgage payment is due. The alert may be delivered to the customer via many different interfaces, such as a text message, and e-mail, a phone call, or an alert next time the customer logs in to the financial network's website. The alert may also contain advertisement and/or other opportunities for credit or loans to assist the customer in covering his financial shortfall.

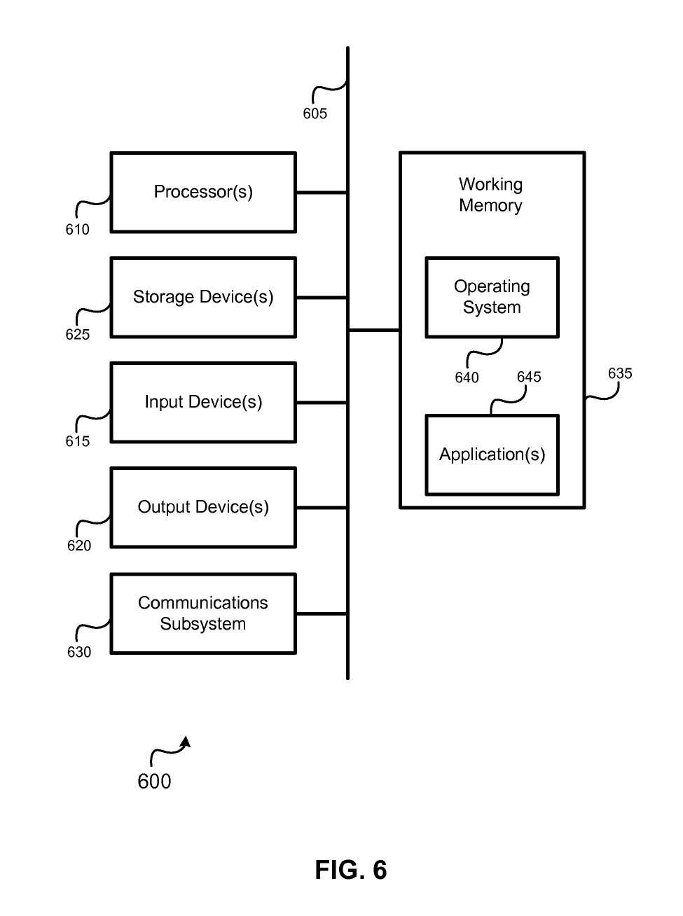

To perform the actions of the financial server system or components of the financial network, such as the financial intelligence module, a computer system as illustrated in FIG. 6 may be used. FIG. 6 provides a schematic illustration of one embodiment of a computer system 600 that can perform the methods provided by various other embodiments, as described herein, and/or can function as the host computer system, a remote kiosk/terminal, a point-of-sale device, a mobile device, and/or a computer system. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements may include one or more processors 610, including without limitation one or more general-purpose processors and/or one or more special-purpose processors (such as digital signal processing chips, graphics acceleration processors, and/or the like); one or more input devices 615, which can include without limitation a mouse, a keyboard and/or the like; and one or more output devices 620, which can include without limitation a display device, a printer and/or the like.

The computer system 600 may further include (and/or be in communication with) one or more non-transitory storage devices 625, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 600 might also include a communications subsystem 630, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 630 may permit data to be exchanged with a network (such as the network described below, to name one example), other computer systems, and/or any other devices described herein. In many embodiments, the computer system 600 will further comprise a working memory 635, which can include a RAM or ROM device, as described above.

The computer system 600 also can comprise software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 625 described above. In some cases, the storage medium might be incorporated within a computer system, such as the system 600. In other embodiments, the storage medium might be separate from a computer system (e.g., a removable medium, such as a compact disc), and or provided in an installation package, such that the storage medium can be used to program, configure and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 600) to perform methods in accordance with various embodiments of the invention. According to a set of embodiments, some or all of the procedures of such methods are performed by the computer system 600 in response to processor 610 executing one or more sequences of one or more instructions (which might be incorporated into the operating system 640 and/or other code, such as an application program 645) contained in the working memory 635. Such instructions may be read into the working memory 635 from another computer-readable medium, such as one or more of the storage device(s) 625. Merely by way of example, execution of the sequences of instructions contained in the working memory 635 might cause the processor(s) 610 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processor(s) 610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 625. Volatile media include, without limitation, dynamic memory, such as the working memory 635. Transmission media include, without limitation, coaxial cables, copper wire and fiber optics, including the wires that comprise the bus 605, as well as the various components of the communication subsystem 630 (and/or the media by which the communications subsystem 630 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600. These signals, which might be in the form of electromagnetic signals, acoustic signals, optical signals and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Further, while the preceding discusses the creation of a personalized financial plan by a financial network, other systems may also be used to create the personalized financial plan. Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for analyzing a customer's financial position and providing a customer with a personalized financial plan, the method comprising:
receiving, by a computer system, an enrollment request to enroll the customer in an interactive financial planning program, wherein the computer system is part of a financial network;
retrieving, by the computer system, from one or more databases, information associated with one or more financial transactions, wherein the one or more financial transactions were previously conducted by the customer;
prompting, by the computer system, the customer with one or more questions regarding the customer's financial position;
receiving, by the computer system, one or more responses from the customer corresponding to the one or more questions regarding the customer's financial position;
identifying, by the computer system, at least partially based on the information associated with one or more financial transactions retrieved from the one or more databases and the responses corresponding to the one or more questions, one or more periodic payments received by the customer through the financial network;
identifying, by the computer system, at least partially based on the information associated with one or more financial transactions retrieved from the one or more databases and the responses corresponding to the one or more questions, one or more periodic payments paid by the customer through the financial network;
creating, by the computer system, a personalized financial plan for the customer at least partially based on the one or more periodic payments paid and the one or more periodic payments received by the customer through the financial network; and
providing, by the computer system, the personalized financial plan to the customer.

2. The method of claim 1, wherein the one or more periodic payments paid by the customer comprise one or more bill payment transactions.

3. The method of claim 1, wherein the personalized financial plan identifies a surplus amount or a shortfall amount using the one or more periodic payments paid by the customer and the one or more periodic payments received by the customer.

4. The method of claim 1, wherein the personalized financial plan comprises at least one suggested payment date for at least one or the one or more periodic payments paid by the customer.

5. The method of claim 1, further comprising prompting, by the computer system, the customer with additional questions regarding the customer's financial situation, wherein:
the additional questions are divided into subsets of additional questions; and
each subset of additional questions is provided to the user during different sessions between the customer and the computer system of the financial network.

6. The method of claim 3, further comprising providing the customer with one or more investment opportunities that may be entered using the financial network, wherein the one or more investment opportunities are provided if the personalized financial plan identifies the surplus amount.

7. The method of claim 3, further comprising providing the customer with one or more credit opportunities that may be entered using the financial network, wherein the one more credit opportunities are provided if the personalized financial plan identifies the shortfall amount.

8. The method of claim 1, further comprising:
determining, by the computer system, based on the periodic payments received by the customer and the periodic payments paid by the customer, the customer will be unable to complete an upcoming periodic payment; and
sending, by the computer system, an alert to the customer, wherein the alert notifies the customer that the customer has insufficient funds to complete the upcoming periodic payment.

9. A computer program product stored on a computer-readable storage medium for analyzing a customer's financial position and providing a customer with a personalized financial plan, the computer program product comprising instructions for:
receiving an enrollment request to enroll the customer in an interactive financial planning program, wherein the computer system is part of a financial network;
retrieving, from one or more databases, information associated with one or more financial transactions, wherein the one or more financial transactions were previously conducted and involved the customer;
prompting the customer with one or more questions regarding the customer's financial position;
receiving one or more responses from the customer that correspond to the one or more questions regarding the customer's financial position;
identifying, at least partially based on the information associated with one or more financial transactions retrieved from the one or more databases and the one or more responses corresponding to the one or more questions, one or more periodic payments received by the customer using the financial network;
identifying, at least partially based on the information associated with one or more financial transactions retrieved from the one or more databases and the one or more responses corresponding to the one or more questions, one or more periodic payments paid by the customer using the financial network;
creating a personalized financial plan for the customer at least partially based on the one or more periodic payments paid and received by the customer through the financial network, and the one or more responses corresponding to the one or more questions regarding the customer's financial position; and
providing the personalized financial plan to the customer.

10. The computer program product of claim 9, wherein the personalized financial plan identifies a surplus amount or a shortfall amount based on the one or more periodic payments paid by the customer and the one or more periodic payments received by the customer.

11. The computer program product of claim 10, wherein the personalized financial plan provides the customer with an estimated surplus amount or shortfall amount for a time period based on the one or more periodic payments paid by the customer and the one or more periodic payments received by the customer.

12. The computer program product of claim 9, wherein the personalized financial plan comprises at least one suggested payment date for at least one of the one or more periodic payments paid by the customer.

13. The computer program product of claim 9, wherein the instructions further comprise instructions for prompting the customer with additional questions regarding the customer's financial situation, wherein:
the additional questions are divided into subsets of additional questions; and
each subset of additional questions is provided to the user during different sessions between the customer and the computer system of the financial network.

14. The computer program product of claim 10, wherein the instructions further comprise instructions for providing the customer with one or more investment opportunities that may be entered through the financial network, wherein the investment opportunities are provided if the financial plan identifies the surplus amount.

15. The computer program product of claim 10, wherein the instructions further comprise instructions for providing the customer with one or more credit opportunities that may be entered through the financial network, wherein the credit opportunities are provided if the financial plan identifies the shortfall amount.

16. The computer program product of claim 9, wherein the instructions further comprise instructions for:
determining, based on the periodic payments received by the customer and the periodic payments paid by the customer, the customer will have insufficient funds to complete an upcoming periodic payment; and
sending an alert to the customer, wherein the alert notifies the customer that the customer has insufficient funds at the present time to complete the upcoming periodic payment.

17. A method for analyzing a customer's financial position and providing a customer with a personalized financial plan, the method comprising:
receiving, by a computer system, an enrollment request to enroll the customer in an interactive financial planning program, wherein the computer system is part of a financial network;
retrieving, by the computer system, from one or more databases, information associated with one or more financial transactions, wherein the one or more financial transactions involved the customer;
identifying, by the computer system, at least partially based on the information associated with one or more financial transactions retrieved from the one or more databases, one or more periodic payments received through the financial network by the customer;
identifying, by the computer system, at least partially based on the information associated with one or more financial transactions retrieved from the one or more databases, one or more periodic payments paid by the customer through the financial network;
creating, by the computer system, a personalized financial plan for the customer at least partially based on the one or more periodic payments paid and received by the customer through the financial network;
providing, by the computer system, the personalized financial plan to the customer;
prompting the customer with additional questions regarding the customer's financial situation, wherein:
the additional questions are divided into subsets of additional questions; and
each subset of additional questions is provided to the user during different sessions between the user and the computer system of the financial network;
receiving, by the computer system, responses to the additional questions from the customer; and
modifying, by the computer system, the personalized financial plan based on the responses to the additional questions received from the customer.

18. The method of claim 17, wherein the customer is provided with a printed copy of the personalized financial plan at an agent location linked to the financial network.

19. The method of claim 17, further comprising displaying, by the computer system, one or more advertisements to the customer, wherein the advertisements are selected based on information present in the personalized financial plan.

20. The method of claim 17, further comprising:
receiving, by the computer system, from a third-party institution, information regarding the customer's financial position; and
modifying, by the computer system, the personalized financial plan based on the information received from the third-party institution.
